(19) United States
(12) Patent Application Publication
(10) Pub. No.: US 2025/0014330 A1
(43) Pub. Date: Jan. 9, 2025

(54) METHOD FOR EXTRACTING AN INTERSECTION AREA FROM A SEGMENTATION MASK

(71) Applicant: WOVEN BY TOYOTA, INC., Tokyo (JP)

(72) Inventor: Jonathan Geoffrey HOUGH, Tokyo (JP)

(73) Assignee: WOVEN BY TOYOTA, INC., Tokyo (JP)

(21) Appl. No.: 18/760,722

(22) Filed: Jul. 1, 2024

(30) Foreign Application Priority Data
Jul. 3, 2023 (JP) 2023-109361

(51) Int. Cl. G06V 20/10; G06V 10/26; G06V 10/762

(52) U.S. Cl. CPC G06V 20/182; G06V 10/26; G06V 10/7635

(57) ABSTRACT

An intersection area extraction method comprising acquiring a mask image; determining whether a target point selected from the mask image is an intersection point; and obtaining an intersection area by applying a clustering algorithm to intersection points, which are obtained by performing said determining step for a plurality of points in the mask image, and determining a resulting cluster area as the intersection area. The determination of a target point being an intersection point comprises: selecting the target point from the mask image; calculating a distance from the target point to a road boundary for a plurality of directions; and determining the target point is the intersection point if a graph, whose horizontal axis is the direction and whose vertical axis is the distance to the road boundary, has more than two peaks, and the target point is not the intersection point otherwise.

### BACKGROUND OF THE DISCLOSURE

### Field of the Invention

The present disclosure relates to extracting an intersection area from a segmentation mask of road area.

### Description of the Related Art

Patent document 1 discloses using Voronoi partitioning to detect lanes and create a map representing the lanes.

### PATENT DOCUMENTS

Patent Document 1: JP2020-201649A

### SUMMARY OF DISCLOSURE

One of the aspects of the present disclosure is to provide a technique that can extract intersection areas from a mask image that indicates whether each pixel corresponds to a road or not.

One of the aspects of the present disclosure is a computer-implemented method for extracting an intersection area, the method comprising: acquiring a mask image representing whether or not each pixel corresponds to a road; determining whether a target point selected from the mask image is an intersection point; and obtaining an intersection area by applying a clustering algorithm to a plurality of intersection points, which are obtained by performing said determining step for a plurality of points in the mask image, and determining a resulting cluster area as the intersection area, wherein determining whether the target point is the intersection point comprises: selecting the target point from the mask image; calculating a distance from the target point to a road boundary for a plurality of directions; and determining the target point is the intersection point if a graph, whose horizontal axis is the direction and whose vertical axis is the distance to the road boundary, has two or more peaks, and the target point is not the intersection point otherwise.

According to the present disclosure, the intersection area can be extracted from the mask image, which indicates whether each pixel corresponds to a road or not.

### BRIEF DESCRIPTION OF THE DRAWINGS

FIG. 1A illustrates the configuration of the road graph generator;

FIG. 1B illustrates an overview of the road network creation process;

FIG. 1C illustrates the segmentation mask (mask image);

FIG. 1D illustrates the road network;

FIG. 2 illustrates a flowchart of the road network creation process;

FIG. 3A illustrates the road information acquisition process;

FIGS. 3B and 3C illustrate the road area;

FIG. 4 illustrates a flowchart of the intersection area extraction process; and

FIGS. 5A to 5E illustrate the intersection area extraction process.

### DESCRIPTION OF THE EMBODIMENTS

There is a need to create a road network that represents the connections between road links. If the intersection area can be recognized in advance when creating a road network, a highly accurate road network can be created. However, there is no known existing technology that can extract intersection areas simply and accurately.

Therefore, the objective is to provide a new technique that can extract intersection areas from segmentation masks (mask images) in a simple and highly accurate manner.

### Overview

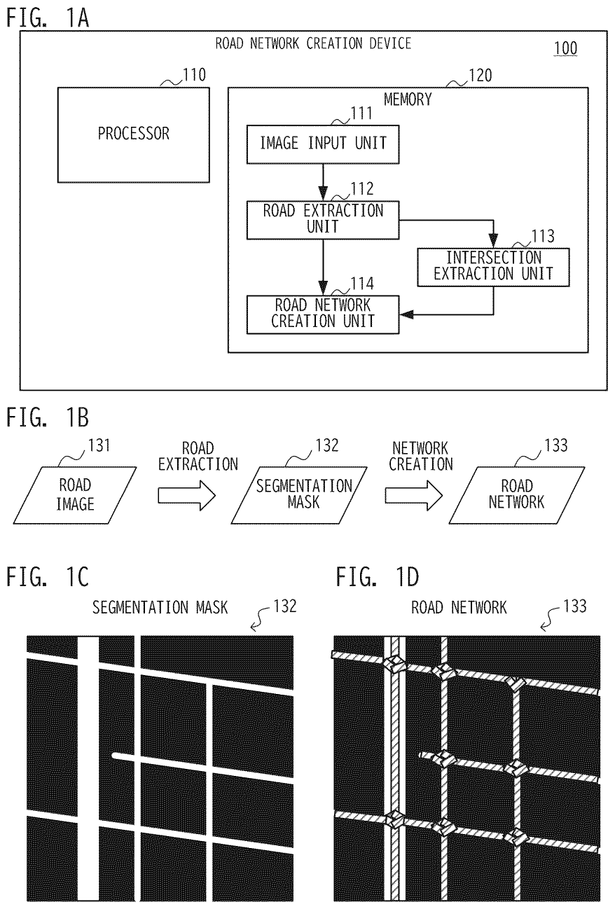

FIG. 1A shows the configuration of a road network creation device (information processor) 100 in one embodiment. The road network creation device 100 has a processor 110 and memory 120. Memory 120 non-transiently stores computer programs for causing processor 110 to function as image input unit 111, road extraction unit 112, intersection extraction unit 113, and road network creation unit 114.

FIG. 1B illustrates the process of creating a road network from road images such as satellite images and aerial images. FIG. 1C illustrates the segmentation mask 132. FIG. 1D illustrates the road network 133. A brief overview of each functional part of the road network creation device 100 will be explained referring to FIGS. 1B to 1D.

The image input unit 111 acquires the road image 131 and stores it in memory 120. The road image 131 is an image of a road, such as a satellite image or an aerial image. The road image 131 may be an image that has undergone pre-processing such as orthographic transformation, concatenation of multiple images, and brightness adjustment.

The road extraction unit 112 performs road extraction processing on the road image 131 to create a segmentation mask (mask image) 312. The road extraction unit 112 determines whether each pixel in the road image 131 corresponds to a road. This decision process may be performed by a machine learning-based process. Specifically, the road extraction unit 112 has a machine-learning model trained using training data labeled as to whether each pixel corresponds to a road or not, and uses this model to determine whether each pixel in the input road image 131 corresponds to a road. In another example, the road extraction unit 112 may determine whether a target pixel corresponds to a road by a rule-based process based on the color and brightness of the target pixel and surrounding pixels. The segmentation mask (mask image) 132 is an image that indicates whether each pixel corresponds to a road or not. FIG. 1C shows an example of a segmentation image of a binary image with white pixels (pixel value “1”) for pixels corresponding to roads and black pixels (pixel value “0”) for pixels not corresponding to roads.

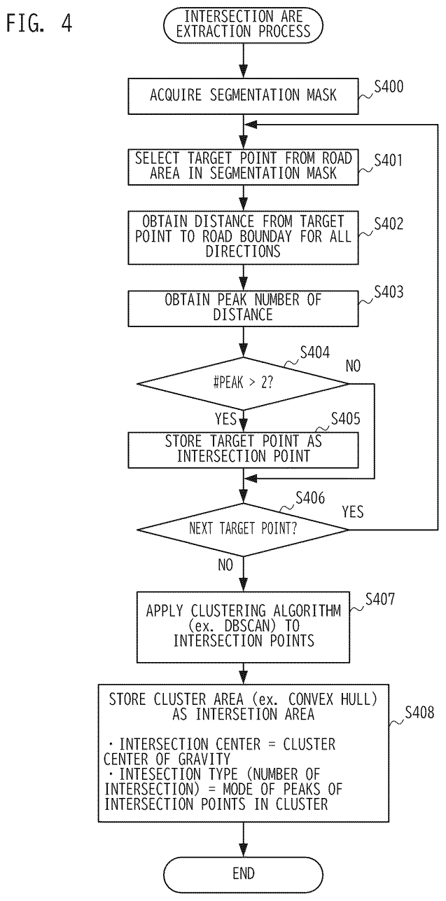

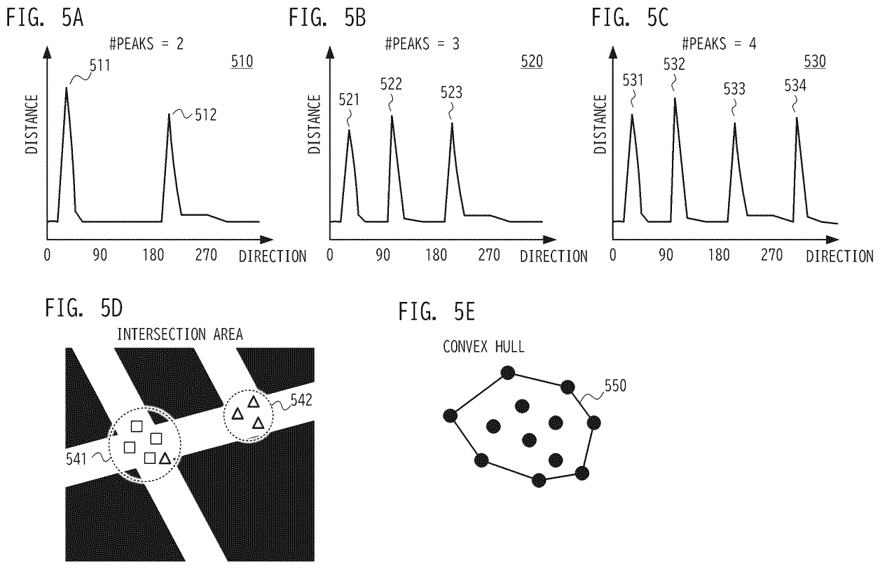

The intersection extraction unit 113 extracts the region of the intersection from the segmentation mask 132. The details of the intersection extraction unit 113 are explained in detail later with reference to FIGS. 4 and 5.

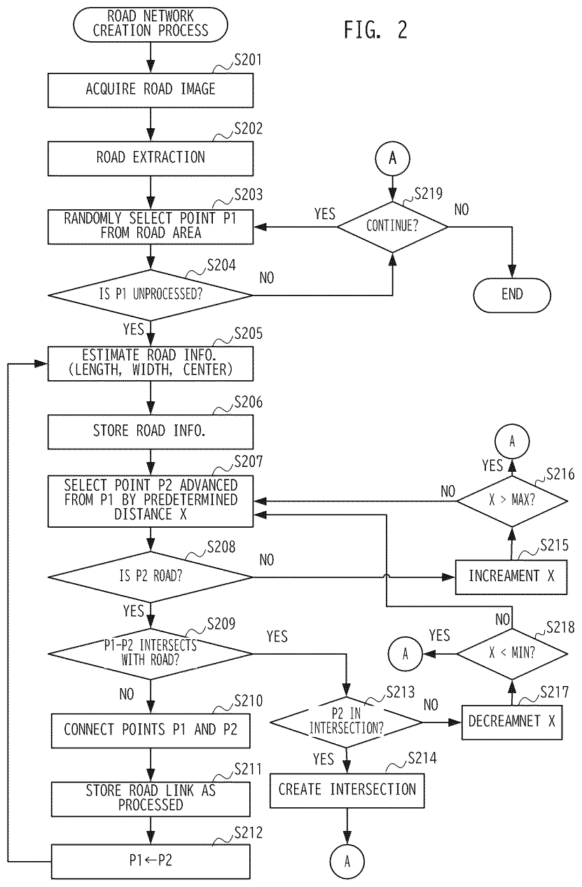

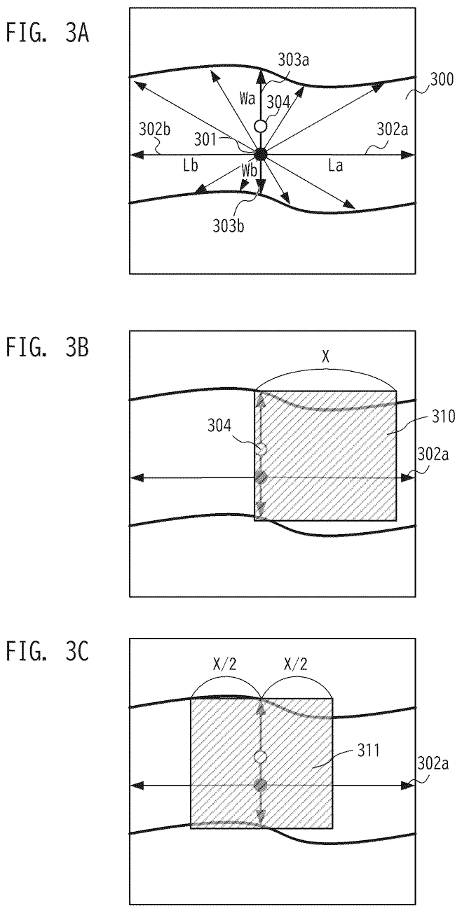

The road network creation unit 114 creates a road network 133 from the segmentation mask 132. The road network 133 is data in a graph structure with connected links representing roads. The details of the road network creation unit 114 are described in detail in FIGS. 2 and 3.

### Road Network Creation Process

FIG. 2 shows a flowchart of the entire road network creation process.

In step S201, the image input unit 111 acquires the road image. In step S202, the road extraction unit 112 determines whether each pixel in the road image corresponds to a road and creates a segmentation mask (mask image).

In step S203, the road network creation unit 114 randomly selects pixels from the group of pixels corresponding to roads in the segmentation mask. In this disclosure, “pixel,” “position,” “point,” and “location” have interchangeable meanings. The point selected in step S203 is called point P1. Point P1 corresponds to the “first point” in this disclosure.

In step S204, the road network creation unit 114 determines whether point P1 is an unprocessed point. If point P1 has not been processed, processing proceeds to step S205; and if it has been processed, processing proceeds to step S219. If the intersection area has been extracted in advance by the intersection extraction unit 113, points within the intersection area can be judged to have been processed.

In order to store whether each pixel has been processed or not, the road network creation unit 114 may use an image with the same shape and the same number of pixels as the segmentation mask 132, which is referred to as an auxiliary image. The auxiliary image is initialized to a value indicating that all pixels are unprocessed (e.g., “0”), and other values are set for processed pixels. The value set for a processed pixel may be a value corresponding to the road ID or, if the pixel is an intersection, a value indicating that it is an intersection. If the point selected in step S203 is unprocessed, the road network creation unit 114 sets the value of the corresponding pixel in the auxiliary image to a value representing processed after step S204. It is only after it is determined that this point corresponds to a road or intersection that the pixel is set to a value according to the road ID or intersection.

In step S205, the road network creation unit 114 estimates the road information at point P1. In one embodiment, the width of the road, the direction of the road, and the center position of the road (centerline position) are estimated as road information. In step S205, the road network creation unit 114 stores the estimated road information in memory 120.

FIG. 3A illustrates the process of estimating road information. In FIG.> 3A, 300 represents the road and 301 represents point P1. The road network creation unit 114 finds the distance to non-road points for each direction centered on point P1. Specifically, the road network creation unit 114 finds the distance La from point P1 (301) to the non-road location for direction 302a and the distance Lb from point P1 (301) to the non-road location for direction 302b opposite to direction 302a, and takes the sum of these distances. The non-road locations include pixels determined not to be roads and the edges of the mask image. The road network creation unit 114 calculates the sum of the distances described above for multiple directions (e.g., all directions at 5-degree intervals) centered at point P1 (301).

The road network creation unit 114 determines the direction with the largest sum of the above mentioned distances as the road direction of road 300, the sum of the distances in the direction orthogonal to the road direction as the road width, and the center position of the road width as the road center (center line position). In the example in FIG. 3A, directions 302a and 302b are determined as road directions. The sum of the distances Wa and Wb of directions 303a and 303b orthogonal to directions 302a and 302b is then determined as the width of road 300. The location 304 of the center of the road widths Wa and Wb is determined as the center location of road 300.

In step S207, the road network creation unit 114 selects as point P2 a location advanced from point P1 by a predetermined distance X along the road direction determined in step S206. Point P2 corresponds to the “second point” in this disclosure. The predetermined distance X may be any value depending on the required accuracy of the system, e.g., 1 m, 2 m, 5 m, 10 m, 20 m (or the equivalent number of pixels).

In step S208, the road network creation unit 114 determines whether point P2 is a road. If point P2 is not a road, the road network creation unit 114 increases the predetermined distance X in step S215, and if X after the increase does not exceed the maximum value (threshold value) (S216-NO), it returns to process S207 to reselect point P2. If X after the increase exceeds the maximum value (S216-YES), the process proceeds to step S219 to determine whether to continue the process, and if so, returns to step S203 to select a new point P1. The increment in step S215 may be a fixed value (e.g., 50 cm, 1 m, etc.), a value depending on the current X (e.g., 10% or 20% of X), or a value depending on the number of repetitions (e.g., 2ⁿ⁻² m for nth repetition). By re-selecting point P2 by increasing the predetermined distance until point P2 is determined to be a road or the predetermined distance X exceeds the threshold value, the process can be quickly recovered if point P2 is erroneously determined not to be a road or point P1 is erroneously determined to be a road in step S202.

In step S209, the road network creation unit 114 determines whether the link connecting points P1 and P2 intersects other road links that have already been found and stored. This determination can be made by checking whether or not any of the pixels on the line connecting points P1 and P2 are assigned a road ID in the auxiliary image. If the road does not intersect with another road, the process proceeds to step S210; if it does, the process proceeds to step S213. In the process of step S209, if the link connecting points P1 and P2 overlaps the intersection area extracted by the intersection extraction unit 113, it may also be regarded as an affirmative decision and the process may proceed to step S213.

In step S210, the road network creation unit 114 connects point P1 and point P2 and stores them as road links. That is, a new road link is generated and stored with point P1 and point P2 as nodes, respectively, and a new road link is generated and stored that ends at both of these nodes. In another embodiment, in the loop process of steps S205 to S212, after the second time, the point P2 may be connected to the end node of the processed road link (current point P1), or the point P2 may be connected to the starting node of the processed road link (initial point P1).

In step S211, the road network creation unit 114 stores the region of road links connecting points P1 and P2 as processed. For example, the road network creation unit 114 connects points P1 and P2 in the auxiliary image, and the area whose width is the road width determined in step S205 is considered processed. In one embodiment, the pixels of the area in the auxiliary image are set to values corresponding to the road ID. In addition to the above, the area of the road link may be determined as an area extending a predetermined distance X in the road direction from the road center 304 at point P1 (301) and having a width of the road width determined in step S205, as shown in FIG. 3B. Alternatively, as shown in FIG. 3C, it may be determined as a region that extends from the road center 304 at point P1 (301) in the road direction and in the opposite direction by half the predetermined distance X, respectively, and has a width of the road width determined in step S205.

In step S212, the current point P2 is set to the new point P1, and the process returns to step S205 (road information estimation process) and thereafter is executed again.

Step S213 is performed when it is determined in step S209 that the link connecting points P1 and P2 intersects another road. In step S213, the road network creation unit 114 determines whether point P2 is located within the intersection area. This determination can be made by checking whether point P2 is located in the intersection area extracted by the intersection extraction unit 113. In other embodiments, the intersection extraction unit 113 may be used to determine whether point P2 is located in the intersection area according to whether point P2 is located on a processed road link or not. If point P2 is not in the intersection area (S213-NO), the road network creation unit 114 decreases the predetermined distance X in step S217, and if X after the decrease is not smaller than the minimum value (threshold value) (S218-NO), the process returns to step S207 and reselect point P2. If X after the decrease is less than the minimum value (S218-YES), the process proceeds to step S219 to determine whether to continue the process, and if so, returns to step S203 to select a new point P1. The decrement in step S217 may be a fixed value (e.g., 50 cm, 1 m, etc.), a value depending on the current X (e.g., 10% or 20% of X), or a value depending on the number of repetitions (e.g., 2¹⁻ⁿm for nth repetition). Thus, when the link between points P1 and P2 intersects another road, but point P2 is not in the intersection area, point P2 can be made a point in the intersection area by moving back the position of point P2.

Step S214 is performed when point P2 is determined to be a point in the intersection area in step S213. In step S214, the road network creation unit 114 generates intersections. Specifically, the road network creation unit 114 creates a new intersection node if one has not been created in the intersection area, and then connects point P1 to the intersection node. If there are already road links connected to the intersection node, the road network creation unit 114 generates a new multiple road links connecting point P1 to the respective road links. For example, if three road links are already connected to an intersection, the road network creation unit 114 generates three road links connecting point P1 to the end points of the above three road links.

The decision to continue processing in step S219 can be determined as appropriate. As an example, it is conceivable that the process is judged to be complete after the selection process of point P1 (S203) has been executed a predetermined number of times. This predetermined number of times can be a value (e.g., 10%) based on the number of pixels that are determined to be roads in the mask image.

### Intersection Area Extraction Process

FIG. 4 illustrates the process of extracting the intersection area from the segmentation mask (mask image). The intersection area extraction process is performed prior to the road network creation process, for example, and is used to determine whether the point to be processed is included in the intersection area in the road network creation process.

In step S400, the intersection extraction unit 113 obtains the segmentation mask (mask image) created by the road extraction unit 112.

The process after step S401 can be divided into two major parts. One part consisting of steps S401-S405 is the process of determining whether or not a single point (point to be processed) is an intersection point. The other part consisting of steps S407-S408 the process of extracting the intersection area based on the intersection points.

In step S401, the intersection extraction unit 113 selects the points to be processed from the points in the road area of the segmentation mask (mask image) 132. The selection method is not limited, and for example, random selection can be employed.

In step S402, the intersection extraction unit 113 obtains the distance from the point to be processed to the road boundary for multiple directions. For example, the intersection extraction unit 113 finds the distance from the processing point to the road boundary over all 360 degrees centered on the processing point. For example, the distance to the road boundary is determined every 5 degrees. Road boundaries are the points in the segmentation mask that are considered non-roads and the edges of the segmentation mask.

In step S403, the intersection extraction unit 113 obtains the number of peaks in a graph with the distance obtained in step S402 as the distance to the road boundary on the vertical axis with the direction (angle) on the horizontal axis. FIGS. 5A to 5C show several examples of such graphs, with two, three, and four peaks, respectively. Any existing peak detection algorithm can be used for the process of finding peaks in the graph. As an example, the find_peaks function in the SciPy library of the Python language is available.

In step S404, the intersection extraction unit 113 determines whether the number of peaks is greater than 2. If the decision is positive, processing proceeds to step S405; if the decision is negative, processing proceeds to step S406.

In step S405, the intersection extraction unit 113 stores the points to be processed as intersection points in memory 120. At this time, the number of peaks obtained in step S403 is also stored in association with the intersection points. Of FIGS. 5A to 5C, FIG. 5A is determined not to be an intersection point because the peak number is 2, while FIGS. 5A and 5B are determined to be intersection points because the peak numbers are 3 and 4.

In step S406, the intersection extraction unit 113 determines whether to process the next target point. For example, the process of steps S401 to S405 can be repeated a predetermined number of times before proceeding to step S407. The predetermined number can be, for example, a value (e.g., 10%) corresponding to the number of pixels that are determined to be roads in the segmentation mask (mask image).

In step S407, the intersection extraction unit 113 applies a clustering algorithm to the intersection points to generate multiple clusters. Algorithms that can be run without specifying the number of clusters to be generated, e.g., DBSCAN, are suitable for use here.

In step S408, the intersection extraction unit 113 stores each of the obtained clusters as an intersection area (intersection area) in memory 120. The intersection area may be determined as the smallest convex polygon (convex hull) that encompasses all intersection points in the cluster, or the smallest rectangle (bounding box) that encompasses all intersections in the cluster. The intersection extraction unit 113 also stores the cluster center of gravity as the intersection center. The intersection extraction unit 113 also determines the number of intersections or intersection types in the intersection area based on the mode (most frequent value) of the peak number of intersection points in the cluster. For example, an intersection area with a mode of 3 peaks is determined to be a three-way or T-type intersection, while an intersection area with a mode of 4 peaks is determined to be a four-way or cross-type intersection. All intersections with a mode of 5 or more peaks may be determined to be complex intersections.

FIG. 5D shows the results of the clustering process, showing the intersection points and the clustering results in the segmentation mask. The points indicated by triangles are intersection points with 3 peaks, and the points indicated by squares are intersection points with 4 peaks. In this example, the clustering process results in two clusters 541, 542. Cluster 541 is determined to be a cross-type intersection because it contains the most intersection points with a peak count of 4. Cluster 542 is determined to be a T-type intersection because it contains the most intersection points with peak number 3. FIG. 5E shows the intersection points in one cluster and the convex hull 550 that encompasses them all. The interior of the convex hull 550 is stored as the intersection area.

### Auxiliary Images

The auxiliary image is an image used as an aid in the road network creation process and has the same shape as the 132 segmentation mask. The auxiliary image is also referred to as the companion image. The initial values of all pixels in the auxiliary image are those representing unprocessed, and the values of pixels selected for processing are updated to those representing processed. Pixels determined to be road links in the road network creation process are assigned a road ID or corresponding value.

By using such auxiliary images, it is easy to determine whether each point (position, pixel) in the segmentation mask has already been processed or not. Since the pixel values in the auxiliary image are set according to the road ID, it is easy to determine which area is the road link with a particular road ID and which road link a particular point (position, pixel) belongs to.

### Advantageous Effect of Embodiment

According to the above implementation, rule-based processing can be used to extract intersection areas and create road networks. Because it is a rule-based process, it can be executed relatively quickly and does not require prior training or collection of training data. In addition, because it is a rule-based process, it is easy to configure according to the required accuracy, i.e., it is possible to extract intersection areas and create road networks with high accuracy that meets the required quality.

### Other Embodiments

The above embodiments are examples only, and the present disclosure may be modified and implemented as appropriate without departing from the gist thereof.

This disclosure can also be realized by supplying a computer program implementing the functions described in the above embodiments to a computer, and having one or more processors of said computer read and execute the program. Such computer programs may be provided to a computer by a non-transitory computer-readable storage medium that can be connected to the computer's system bus, or may be provided to a computer over a network. Non-transitory computer-readable storage media include, for example, magnetic disks (floppy (registered trademark) disks, hard disk drives (HDDs), etc.), optical disks (CD-ROMs, DVD disks, Blu-ray disks, etc.) of any type, read-only memory (ROM), random access memory (RAM), EPROM, EEPROM, magnetic cards, flash memory, optical cards, and any type of media suitable for storing electronic instructions.

What is claimed is:

1. A computer-implemented method for extracting an intersection area, the method comprising:
acquiring a mask image representing whether or not each pixel corresponds to a road;
determining whether a target point selected from the mask image is an intersection point; and
obtaining an intersection area by applying a clustering algorithm to a plurality of intersection points, which are obtained by performing said determining step for a plurality of points in the mask image, and determining a resulting cluster area as the intersection area,
wherein determining whether the target point is the intersection point comprises:
selecting the target point from the mask image;
calculating a distance from the target point to a road boundary for a plurality of directions; and
determining the target point is the intersection point if a graph, whose horizontal axis is the direction and whose vertical axis is the distance to the road boundary, has more than two peaks, and the target point is not the intersection point otherwise.

2. The method according to claim 1,
wherein the determining the target point is the intersection point comprises storing a number of the peaks at the intersection point, and
wherein obtaining the intersection area comprises determining a mode of the number of the peaks at the intersection points in the intersection area, as a number of intersections in the intersection area.

3. The method according to claim 1, wherein obtaining the intersection area comprises determining a center of gravity of the cluster area, as a center of the intersection area.

4. A computer-implemented method for generating a road network, the method comprising:
selecting a point corresponding to a road from a mask image representing whether or not each pixel corresponds to a road, as a first point;
estimating a road information at the first point;
selecting a point at a predetermined distance from the first point, as a second point;
storing a link between the first point and the second point as a road link, in response to a determination that the link between the first point and the second point does not intersect another road link; and
determining if the second point is in an intersection area in response to a determination that the link between the first point and the second point intersects another road link, and performing a process according to whether the second point is in the intersection area or not,
wherein the determining if the second point is in the intersection area is performed using intersection area extracted in advance by the method according to claim 1.

5. An information processing apparatus comprising a processor and a memory storing a computer-program which, when executed by the processor, causes the processor to perform the method of claim 1.
